(19) United States
(12) Patent Application Publication
(10) Pub. No.: US 2025/0365509 A1
(43) Pub. Date: Nov. 27, 2025

(54) IMAGE PROCESSING APPARATUS, IMAGE PROCESSING METHOD, AND COMPUTER READABLE RECORDING MEDIUM

(71) Applicant: CANON KABUSHIKI KAISHA, Tokyo (JP)

(72) Inventor: KYOSUKE KAWANO, Chiba (JP)

(21) Appl. No.: 19/206,472

(22) Filed: May 13, 2025

(30) Foreign Application Priority Data
May 23, 2024 (JP) 2024-084062

(51) Int. Cl. H04N 23/68

(52) U.S. Cl. CPC H04N 23/683; H04N 23/6811

(57) ABSTRACT

An image processing apparatus includes: an image blur amount calculation unit configured to calculate a first blur amount per frame based on a blur amount between images apart from each other by a predetermined number of frames among consecutive images captured by an imaging apparatus; an inertia blur amount calculation unit configured to calculate a second blur amount per frame based on inertia information of a plurality of frames detected in response to shaking of the imaging apparatus; and a blur amount combining unit configured to subtract a difference from the inertia information to calculate a third blur amount used for stabilization of the consecutive images captured by the imaging apparatus, the difference obtained by subtracting the first blur amount from the second blur amount.

### BACKGROUND OF THE INVENTION

### Field of the Invention

The present disclosure relates to a blur correction function of a video.

### Description of the Related Art

Many stabilizing techniques for a video captured by an imaging apparatus have been conventionally proposed. For example, there is a stabilizing technique in which a stabilizing process is performed on a video by using a blur amount calculated based on inertia information expressing a rotation amount of an imaging apparatus obtained by a gyroscope sensor. Moreover, for example, there is a stabilizing technique in which a stabilizing process is performed on a video captured by an imaging apparatus by using a blur amount calculated based on the captured video.

The stabilizing technique using the gyroscope sensor has advantages such as high robustness and a small calculation amount, but has such disadvantages that the inertia information includes offset components unique to the gyroscope sensor as well and does not include translational components of the imaging apparatus. Meanwhile, the stabilizing technique using the captured video has such an advantage that the blur amount includes not only rotational components but also translational components of the imaging apparatus, but also has such disadvantages that the technique lacks robustness and calculation of the blur amount includes a process that takes time such as processing of feature points in images of the respective frames.

As a method of compensating the disadvantages in both techniques, there is proposed a technique of Japanese Patent Laid-Open No. 2018-205551 (hereinafter, referred to as Literature 1). In Literature 1, correction is performed by using not only a blur amount based on inertia information but also a blur amount based on a video captured by an imaging apparatus to improve accuracy.

In Literature 1 described above, the blur amount based on the inertia information and the blur amount based on the image captured by the imaging apparatus are combined in a unit of frame. Accordingly, the technique of Literature 1 has such a problem that the blur amount based on the captured image needs to be calculated for each frame, and processing time of the stabilizing process is long.

### SUMMARY OF THE INVENTION

An image processing apparatus according to one aspect of the present disclosure includes: an image blur amount calculation unit configured to calculate a first blur amount per frame based on a blur amount between images apart from each other by a predetermined number of frames among consecutive images captured by an imaging apparatus; an inertia blur amount calculation unit configured to calculate a second blur amount per frame based on inertia information of a plurality of frames detected in response to shaking of the imaging apparatus; and a blur amount combining unit configured to subtract a difference from the inertia information to calculate a third blur amount used for stabilization of the consecutive images captured by the imaging apparatus, the difference obtained by subtracting the first blur amount from the second blur amount.

Further features of the present invention will become apparent from the following description of exemplary embodiments with reference to the attached drawings.

### BRIEF DESCRIPTION OF THE DRAWINGS

FIG. 1 is a diagram explaining a physical configuration of the present disclosure;

FIG. 2A is a diagram illustrating an example of the logical configuration that functions in the case where the CPU executes a program stored in the ROM while using the RAM as a work memory, and FIG. 2B is a diagram illustrating an outline of three elements of pan, tilt, and roll;

FIG. 3 is a graph explaining an outline of the present disclosure;

FIG. 4 is a diagram in which both of a gyroscope blur amount and an image blur amount are calculated every frame;

FIG. 5 is a diagram in which the gyroscope blur amount is calculated every one frame and the image blur amount is calculated every five frames;

FIG. 6 is a conceptual diagram of calculation of a difference between the gyroscope blur amount and the image blur amount of FIG. 5 for every five frames;

FIG. 7 is a conceptual diagram of calculation of a combined blur amount for every one frame based on the difference of FIG. 6;

FIGS. 8A and 8B are diagrams explaining inertia information included in a video file, FIG. 8A is a diagram illustrating a logical configuration example of the video file recorded by the imaging apparatus, and FIG. 8B is a diagram illustrating a logical configuration example of metadata included in the video file;

FIG. 9A is a diagram illustrating an example of the GUI displayed on the display of FIG. 1, and FIG. 9B is a diagram illustrating examples of relationships between the items of an imaging condition option and frame intervals;

FIG. 10 is a flowchart explaining an operation example of Embodiment 1;

FIG. 11 is a diagram schematically illustrating a first blur amount in S1006 of FIG. 10;

FIG. 12 is a diagram schematically illustrating a second blur amount in S1007 of FIG. 10;

FIG. 13 is a diagram schematically illustrating a difference in S1008 of FIG. 10;

FIG. 14 is a diagram schematically illustrating a third blur amount in S1009 of FIG. 10;

FIG. 15 is a diagram explaining a relationship between the blur amounts and the images;

FIG. 16 is a block diagram illustrating a logical configuration of Embodiment 2;

FIG. 17 is a schematic diagram in which a frame interval of the image blur amount is changed in a low frequency portion and in a high frequency portion in Embodiment 2;

FIG. 18 is a diagram explaining an analysis result of the inertia information in Embodiment 2;

FIG. 19 is a graph explaining an outline of Embodiment 2; and

FIG. 20 is a flowchart explaining an operation example of Embodiment 2.

### DESCRIPTION OF THE EMBODIMENTS

Preferable embodiments of the present disclosure are explained below in detail with reference to the attached drawings. Note that the following embodiments do not limit the matters of the present disclosure, and combinations of characteristics explained in the following embodiments are not necessarily essential for solving means of the present disclosure. Note that the same constituent elements are denoted by the same reference numerals.

### Embodiment 1

### Outline

Many techniques for stabilizing a video captured by an imaging apparatus have been conventionally proposed. Among the many stabilizing techniques, there is a technique in which a stabilizing process is performed on a video by using a blur amount calculated based on inertia information obtained by a gyroscope sensor. The stabilizing technique using the gyroscope sensor has advantages such as high robustness and a small calculation amount, but also has such a disadvantage that the inertia information includes an offset component unique to the gyroscope sensor and does not include a translational component of the imaging apparatus. Moreover, among stabilizing techniques, there is a technique in which a stabilizing process is performed on a video captured by the imaging apparatus by using a blur amount calculated based on the captured video. The stabilizing technique using the captured video has such an advantage that the blur amount includes not only a rotational component but also a translational component of the imaging apparatus, but also has such a disadvantage that the technique lacks robustness and calculation of the blur amount includes a process that takes time such as processing of feature points in images of the respective frames. Accordingly, in the present disclosure, the blur amount based on the video captured by the imaging apparatus is used at an interval of several frames, and the blur amount calculated based on the inertia information obtained by the gyroscope sensor is used for each of the frames in a range of the several frames. According to such an operation, the present disclosure can remove the offset component of the inertia information and also achieve an increase in speed of the stabilizing process while maintaining accuracy of the blur amount of the image. The present disclosure is specifically explained below.

### Embodiment 1

### Configuration of Image Processing Apparatus

### Physical Configuration

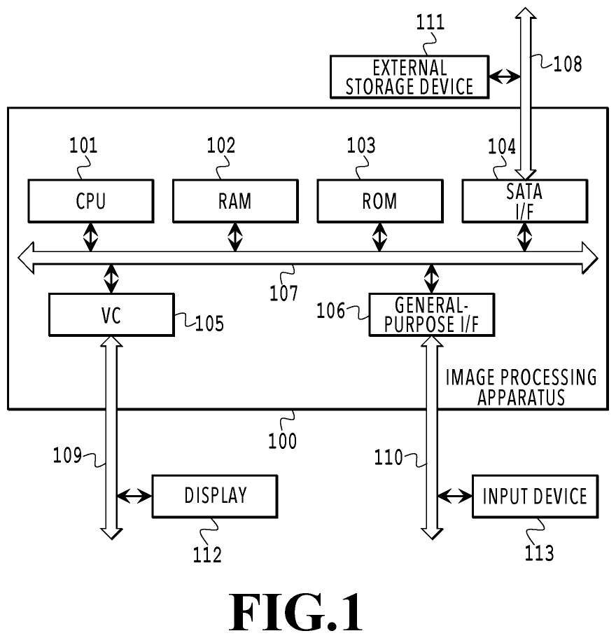

FIG. 1 is a diagram explaining a physical configuration of the present disclosure. An image processing apparatus 100 includes a CPU 101, a RAM 102, a ROM 103, a serial ATA (SATA) interface (I/F) 104, a video card (VC) 105, and a general-purpose I/F 106. Each of the CPU 101, the RAM 102, the ROM 103, the SATA I/F 104, the VC 105, and the general-purpose I/F 106 is connected via a system bus 107.

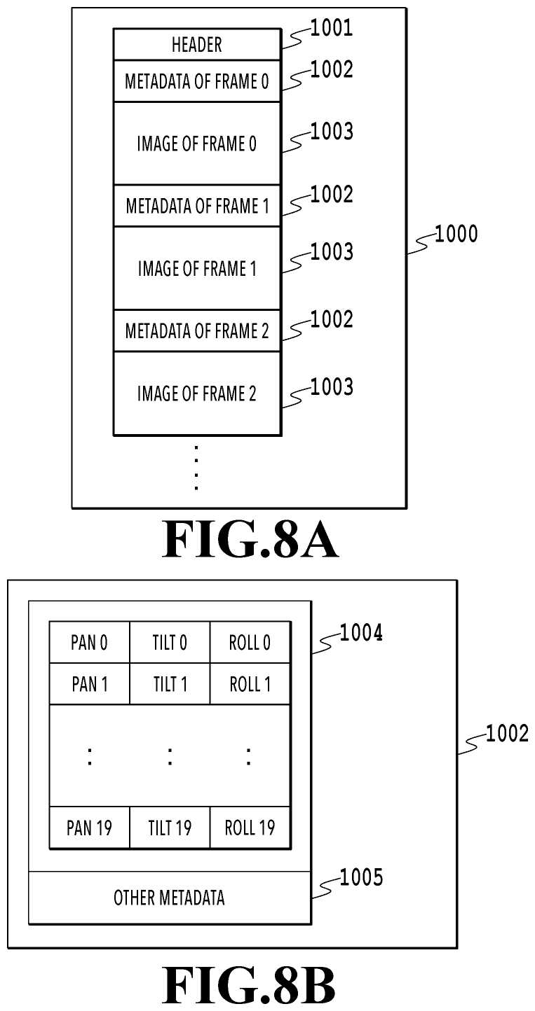

The CPU 101 executes an operating system (OS) and various programs stored in the ROM 103, an external storage device 111, and the like by using the RAM 102 as a work memory. Note that the OS and the various programs may be stored in an internal storage device. Moreover, the CPU 101 controls various configurations via the system bus 107. Note that the CPU 101 executes a process of a flowchart to be described later by loading program codes stored in the ROM 103, the external storage device 111, and the like onto the RAM 102. The external storage device 111 is connected to the SATA I/F 104 via a serial bus 108. The external storage device 111 is a hard disk drive (HDD) or a solid state drive (SSD). A display 112 is connected to the VC 105 via a serial bus 109. An input device 113 such as a mouse and a keyboard is connected to the general-purpose I/F 106 via a serial bus 110. The CPU 101 displays a graphical user interface (GUI) provided by a program on the display 112, and receives input information expressing an instruction of a user obtained via the input device 113. The image processing apparatus 100 is implemented by, for example, a desktop personal computer (PC). Alternatively, the image processing apparatus 100 may be implemented by a laptop PC, a tablet PC, or the like integrated with the display 112. Moreover, the external storage device 111 is implemented also by a medium (recording medium) and an external storage drive for accessing this medium. A flexible disk (FD), a CD-ROM, a DVD, a USB memory, an MO, a flash memory, or the like can be used as the medium. For example, a video file 1000 (explained by using FIGS. 8A and 8B) of a video captured by the imaging apparatus is assumed to be saved in a flash memory such as a SD card. FIGS. 8A and 8B are diagrams explaining the inertia information included in the video file 1000. FIG. 8A is a diagram illustrating a logical configuration example of the video file 1000 recorded by the imaging apparatus. The video file 1000 includes a header 1001, metadata 1002, and image data 1003. Information on the number of frames in the video file 1000, a compression format of the video file 1000, and the like is stored in a logical region of the header 1001. Each of a logical region of the metadata 1002 and a logical region of the image data 1003 is formed for each frame. In the example of FIG. 8A, the metadata 1002 and the image data 1003 for frames 0 to 2 are formed for simplification. In actual, as many as the stored number of frames in the logical region of the header 1001, logical regions of the metadata 1002 and logical regions of the image data 1003 are alternately arranged and assigned. FIG. 8B is a diagram illustrating a logical configuration example of the metadata 1002 included in the video file 1000. A logical region of inertia information 1004 and a logical region of other metadata 1005 are assigned in the logical region of the metadata 1002. Information indicating each of pan, tilt, and roll for each frame is stored in the logical region of the inertia information 1004. The gyroscope sensor detects a rotation amount as an angular velocity at a cycle of several hundred Hz to several kHz. The example of FIG. 8B is assumed to be a use case in which the angular velocity is obtained by the gyroscope sensor at 600 Hz, and the frame rate of the video file 1000 is 30 fps. Accordingly, as illustrated in FIG. 8B, 600−30=20 pans, tilts, and rolls are included in the inertia information 1004. Note that, for example, imaging information of an exposure, a focal distance, and the like of the imaging apparatus is stored in the logical region of the other metadata 1005. The other metadata 1005 is not used in the present embodiment. Accordingly, detailed explanation of the other metadata 1005 is omitted. Assuming that the video file 1000 is stored in the flash memory as described above, the image processing apparatus 100 can obtain the video file 1000 via the flash memory. The image processing apparatus 100 can obtain the inertia information and the like by referring to the obtained video file 1000.

### Logical Configuration

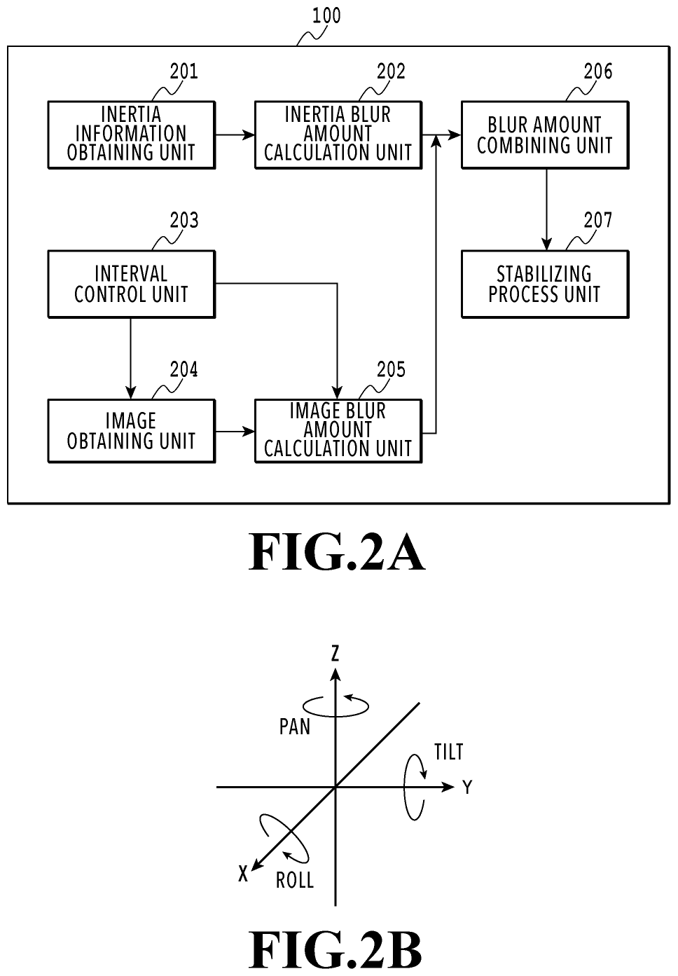

FIG. 2A is a diagram illustrating an example of the logical configurations that function in the case where the CPU 101 executes a program stored in the ROM 103 by using the RAM 102 as the work memory. Note that not all of processes described below have to be executed by the CPU 101, and the image processing apparatus 100 may be configured such that some or all of the processes are executed by one or multiple processing circuits other than the CPU 101.

The image processing apparatus 100 includes logical configurations of an inertia information obtaining unit 201, an inertia blur amount calculation unit 202, an interval control unit 203, an image obtaining unit 204, an image blur amount calculation unit 205, a blur amount combining unit 206, and a stabilizing process unit 207. The inertia information obtaining unit 201 obtains the inertia information for each time from the video file. The inertia information is generated by the gyroscope sensor incorporated in the imaging apparatus, and is recorded in the video file 1000 as described above by using FIGS. 8A and 8B. Note that the gyroscope sensor may be combined with an acceleration sensor, a global navigation satellite system (GNSS), or the like. Information other than the inertia information including three elements of pan, tilt, and roll may be thereby recorded as additional information. FIG. 2B is a diagram illustrating an outline of the three elements of pan, tilt, and roll. As illustrated in FIG. 2B, in X, Y, and Z axes orthogonal to one another, a rotational angular velocity of the X axis (roll axis) is referred to as roll, a rotational angular velocity of the Y axis (tilt axis) is referred to as tilt, and a rotational angular velocity of the Z axis (pan axis) is referred to as pan. Each of the rotational angular velocities of pan, tilt, and roll is detected by the gyroscope sensor incorporated in the imaging apparatus.

The inertia blur amount calculation unit 202 converts the inertia information to a gyroscope blur amount V_{gyro}. The data obtained from the gyroscope sensor as the inertia information is expressed as an angular velocity [degree/second] indicating a rotational amount per second. Accordingly, the inertia information is converted to the gyroscope blur amount V_{gyro} by converting the data obtained from the gyroscope sensor to a unit of [degree/frame] by dividing the obtained data by the frame rate. Note that, since the data obtained from the gyroscope sensor includes the three elements of pan, tilt, and roll, the gyroscope blur amount V_{gyro} can be expressed as a vector including the three elements of pan, tilt, and roll. Moreover, the inertia blur amount calculation unit 202 calculates a second blur amount V₂ based on the gyroscope blur amount V_{gyro}. For example, the gyroscope blur amounts V_{gyro} of each of pan, tilt, and roll in the predetermined number of frames (k) from a frame i+1 to a frame i+k are averaged. The second blur amount V₂ including three elements of pan, tilt, and roll is calculated as an average rotation amount in a range of k frames by this averaging. Note that the calculation of averaging is, for example, arithmetic averaging, but is not limited to this in particular. For example, the calculation may be any of weighted averaging, geometric averaging, and harmonic averaging.

The interval control unit 203 determines a frame interval of the images to be selected by the image blur amount calculation unit 205. The frame interval is an interval longer than an interval of frames captured by the imaging apparatus. For example, the predetermined number of frames (k) is set as the frame interval. The image obtaining unit 204 obtains an image of a frame i and an image of the frame i+k. The image blur amount calculation unit 205 calculates an image blur amount V_{img} from the image of the frame i and the image of the frame i+k, and converts the image blur amount V_{img} to a blur amount per frame to calculate a first blur amount V₁. Specifically, the image blur amount calculation unit 205 calculates a motion vector from the image of the frame i and the image of the frame i+k, and calculates the image blur amount V_{img} based on the calculated motion vector. More specifically, the image blur amount V_{img} is calculated by optimizing a rotation amount of a three-dimensional rotation process performed on coordinates of a feature point detected in the image of the frame i such that a squared error between rotated coordinates obtained by performing the rotation process on the coordinates and coordinates of a feature point in the frame i+k is minimized. Note that, since the image blur amount V_{img} is the blur amount V_{img} between the images as described above, the image blur amount V_{img} is also referred to as blur amount V_{img} between images as appropriate in the following explanation.

The blur amount combining unit 206 combines the first blur amount V₁ and the second blur amount V₂ to calculate a third blur amount V₃. For example, the third blur amount V₃ of the frame i+1 to the frame i+k is calculated as V₃=V_{gyo}−D for each of the gyroscope blur amounts V_{gyro} of the frame i+1 to the frame i+k. D is a difference between the first blur amount V₁ and the second blur amount V₂, and is calculated by subtracting the second blur amount V₂ from the first blur amount V₁. Moreover, D is an average value in the range of k frames.

The stabilizing process unit 207 performs the stabilizing process on the video based on the third blur amount V₃. The third blur amount V₃ indicates a rotation vector from a one previous frame. Accordingly, in the case where a current frame is rotated in a direction opposite to this rotation vector, the current frame that is not rotated (not blurred) with respect to the previous frame can be obtained.

### Outline of Present Disclosure

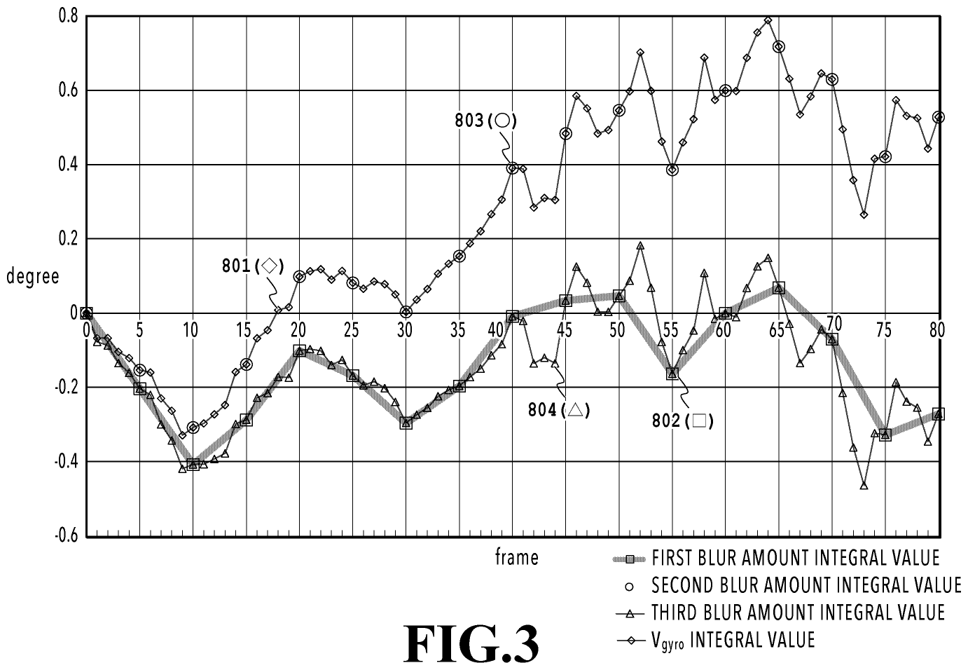

FIG. 3 is a graph explaining an outline of the present disclosure. The horizontal axis of FIG. 3 is set to frame. Meanwhile, in the vertical axis of FIG. 3, the value of the gyroscope sensor is expressed as the angular velocity [degree/second], and the blur amount used in the stabilizing process is expressed as the value of the gyroscope sensor converted to a unit of angular change amount per frame [degree/frame]. Note that, in FIG. 3, in order to clearly express an increase of the difference between the gyroscope blur amount and the image blur amount due to accumulation of a drift component included in the gyroscope blur amount, the vertical axis of FIG. 3 is set to a direction [degree] obtained by integration of the angular change amount per frame. In the graphs in the following explanation, a graph in which the vertical axis is [degree] is assumed to be a graph taking the accumulation of drift component into account, and a graph in which the vertical axis is [degree/frame] is assumed to be a graph taking the blur amount of the present disclosure into account. First blur amount V₁ integral values, second blur amount V₂ integral values, third blur amount V₃ integral values, and gyroscope blur amount V_{gyro} integral values are illustrated in FIG. 3.

The gyroscope blur amount V_{gyro} integral value is illustrated by a line connecting points of rhombus symbols to one another. For example, each of points 801 is a value obtained by integrating gyroscope blur amounts V_{gyro} of a 0 frame to a corresponding frame, the gyroscope blur amounts V_{gyro} obtained from the gyroscope sensor mounted in the imaging apparatus. Note that the gyroscope blur amounts V_{gyro} include offset components. Accordingly, in the case where the gyroscope blur amounts V_{gyro} continue to be integrated, the offset components are accumulated. Thus, each of the gyroscope blur amount V_{gyro} integral values gradually increases with proceeding of the frames. Specifically, a small error in the gyroscope sensor causes drift in which each of the gyroscope blur amount V_{gyro} integral values increases with proceeding of the frames.

Each of the first blur amount V₁ integral values is illustrated by a bold line connecting points of square symbols to one another. For example, each of the points 802 is a value obtained by integrating the first blur amounts V₁ from the 0 frame to a corresponding frame. Each of the first blur amounts V₁ is obtained by converting the image blur amount V_{img} calculated from the motion vector of the images between the frames in the video obtained by the imaging apparatus into the image blur amount V_{img} per frame. Note that the calculation of each of the image blur amount V_{img} is not performed every frame but is performed every several frames. In the example of FIG. 3, each of the image blur amount V_{img} is calculated every five frames. Accordingly, each of the integral values of the first blur amount V₁ is present only every five frames. Thus, it is impossible to determine how the imaging apparatus is moving in each of sections of the bold line connecting the points of square symbols to each other by using only the first blur amount V₁.

Each of the second blur amount V₂ integral values is illustrated by a line connecting points of circle symbols to one another. For example, each of points 803 is the gyroscope blur amount V_{gyro} integral value at the same interval as that of the first blur amount V₁. In the example of FIG. 3, the interval of the second blur amount V₂ integral value is an interval of five frames. Accordingly, each of the points 803 is arranged at the interval of five frames.

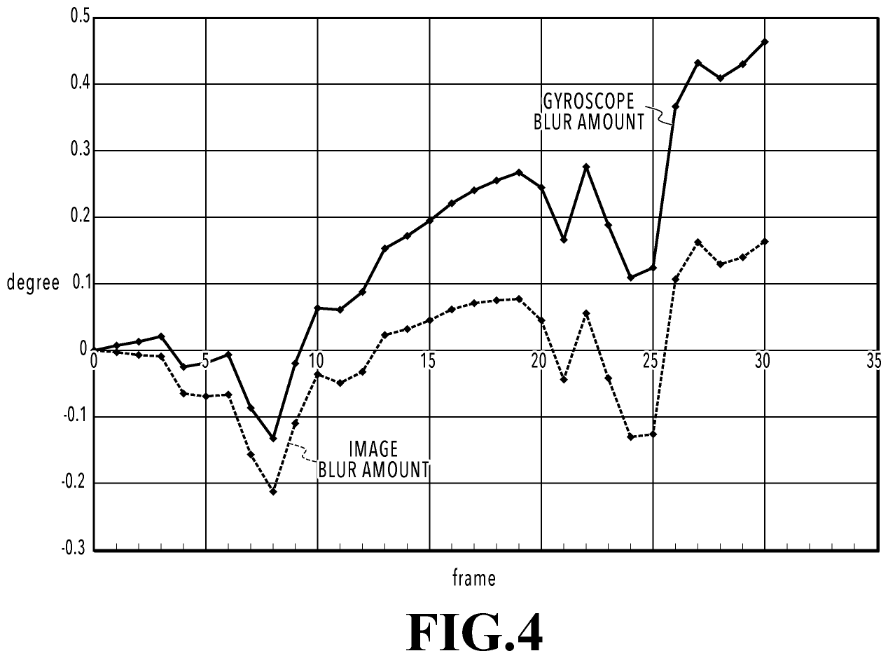

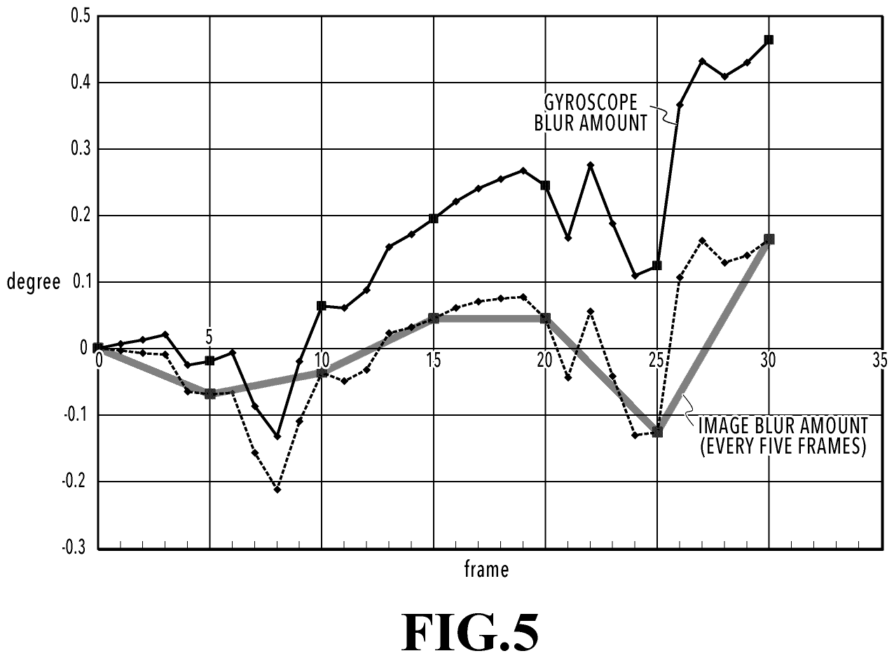

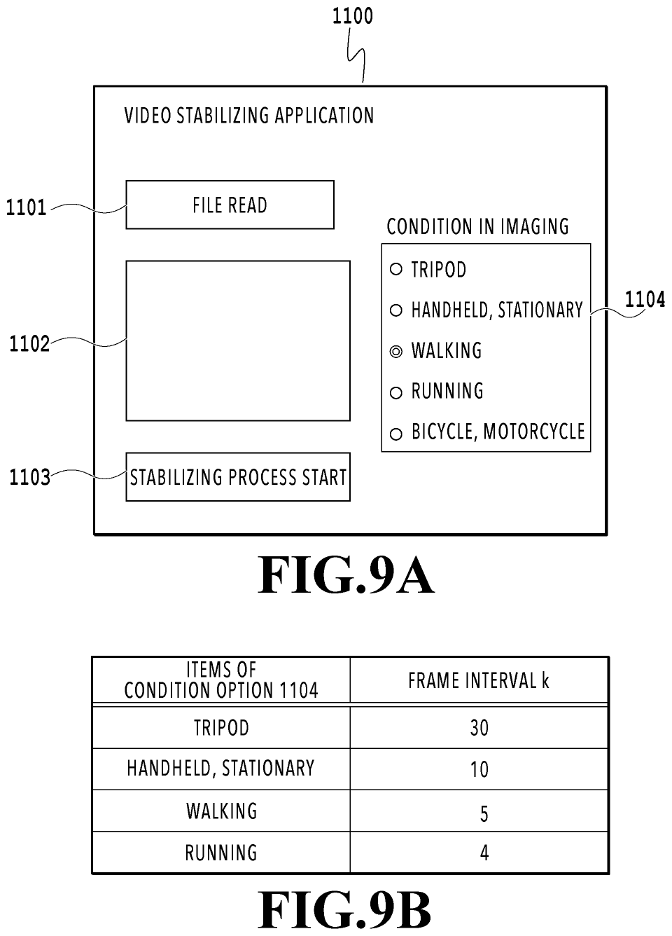

Each of the third blur amount V₃ integral value is illustrated by a line connecting points of triangle symbols to one another. For example, each of points 804 is the third blur amount V₃ integral value. The third blur amount V₃ integral value is explained by using FIGS. 4 to 7 and FIGS. 9A and 9B. FIG. 4 is a diagram in which both of the gyroscope blur amount and the image blur amount are calculated every one frame. The gyroscope blur amount is not affected by an imaged object. Accordingly, the stabilizing process using the gyroscope blur amount has high robustness. Moreover, since the gyroscope blur amount can be obtained only by performing unit conversion on the inertia information, the calculation amount is small. Thus, processing at high speed is possible. However, the gyroscope blur amount includes the offset components generated by a thermal property of the gyroscope sensor. Accordingly, a phenomenon referred to as drift in which integral errors are added up one by one occurs in the integral value of the gyroscope blur amounts as illustrated in FIG. 4, unless the offset components are removed. Accordingly, an accurate stabilizing process cannot be performed by using each of the integral values of the gyroscope blur amounts as it is. Moreover, since the inertia information includes only the rotational blur components of the imaging apparatus such as pan, tilt, and roll, the inertia information includes no translational components in the respective axial directions of pan, tilt, and roll. Accordingly, in the stabilizing process using only the inertia information, the accuracy of the stabilizing process decreases in the case where translational blur is occurring in the imaging apparatus. Meanwhile, each of the image blur amounts is obtained by calculating the movement amount between the frames from the video. Accordingly, each of the image blur amounts includes not only the rotational components but also the translational components of the imaging apparatus. Thus, in the stabilizing process using each of the image blur amounts, the accuracy of the stabilizing process does not decrease also in the case where the translational blur is occurring in the imaging apparatus. However, in the case where a moving object is present among the objects, a change in the video caused by motion of the moving object is erroneously recognized as motion of the imaging apparatus, and the image blur amount is incorrectly calculated in some cases. Accordingly, in the case where a moving object is present among the objects, the stabilizing process using the image blur amount lacks robustness. Moreover, the process of calculating the image blur amount from the video includes processes that take time such as a feature point detection process, a feature point matching process, and an optimization process. Accordingly, the speed of the process of calculating the image blur amount from the video is lower than the speed of the calculation of the gyroscope blur amount from the inertia information. Therefore, each of the image blur amounts is calculated for every predetermined number of frames. FIG. 5 is a diagram in which each of the gyroscope blur amounts is calculated every frame and each of the image blur amounts is calculated every five frames. As illustrated in FIG. 5, for example, the image blur amount between an image of a frame 20 and an image of a frame 25 is calculated. In the case where the predetermined number of frames is five frames as described above, the image blur amount between the images apart from each other at the interval of five frames is calculated. A setting example of the frame interval is explained by using FIGS. 9A and 9B.

FIG. 9A is a diagram explaining a GUI displayed on the display 112 of FIG. 1. An application 1100 is displayed as the GUI. As the name of the application 1100, the application name of “video stabilizing application” is displayed on the GUI of the application 1100. A file read button 1101, a preview region 1102, a stabilizing process start button 1103, and an imaging condition option 1104 are arranged on the GUI of the application 1100 as elements of the GUI. The file read button 1101, the stabilizing process start button 1103, and the imaging condition option 1104 are elements of the GUI assumed to be selected by the user with the input device 113 of FIG. 1.

For example, in the case where the user selects the file read button 1101, a GUI for designating a video file is displayed. Since the GUI for designating a video file is common in a PC, a smartphone, and the like, explanation thereof is omitted. In the case where a video file is designated, contents of the designated video file is displayed in the preview region 1102. In the case where the user selects the stabilizing process start button 1103, the operation of the image processing apparatus 100 is started, and the video file subjected to the stabilizing process is generated. Multiple items for instructing and inputting a condition of the imaging apparatus in capturing of the video captured by the imaging apparatus are displayed in the imaging condition option 1104. In a case where the user selects an item of the items in the imaging condition option 1104 through the input device 113 of FIG. 1, a single circle to the left of the selected item changes to a double circle, and a previous double circle changes to a single circle. Each of these items is associated with a value of the frame interval k. An example of the frame interval k corresponding to each of the items in the imaging condition option 1104 is illustrated in the table of FIG. 9B. FIG. 9B is a diagram illustrating examples of relationships between the items in the imaging condition option 1104 and the frame intervals k. The more intense the motion in the condition is, the smaller the value of k is set to. Moreover, in the case where the user selects the stabilizing process start button 1103 of FIG. 9A and starts the stabilizing process, the value corresponding to the item selected in the imaging condition option 1104 is inputted into the interval control unit 203 as the frame interval k.

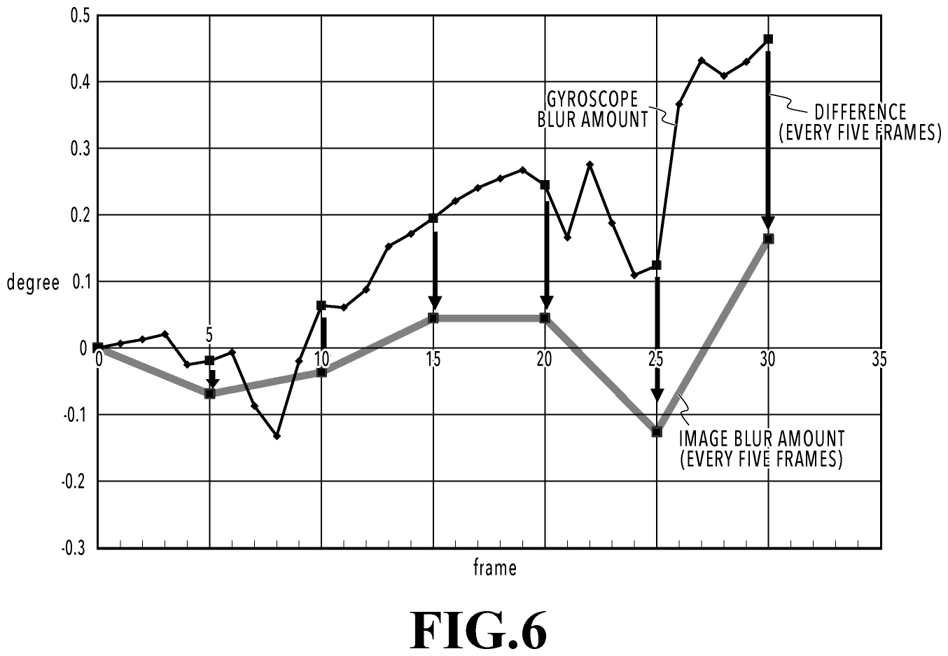

Next, a difference between the gyroscope blur amount and the image blur amount is calculated every five frames. FIG. 6 is a conceptual diagram of calculation of the difference between the gyroscope blur amount and the image blur amount of FIG. 5 at every five frames. Note that, although the image blur amount is subtracted from the gyroscope blur amount every five frames in concept, in the present embodiment, the calculation is as follows in actual as described above by using FIGS. 2A and 2B. Specifically, there is performed a process of subtracting the first blur amount obtained by converting the image blur amount to the blur amount per frame from the second blur amount calculated by averaging the gyroscope blur amounts of the multiple frames.

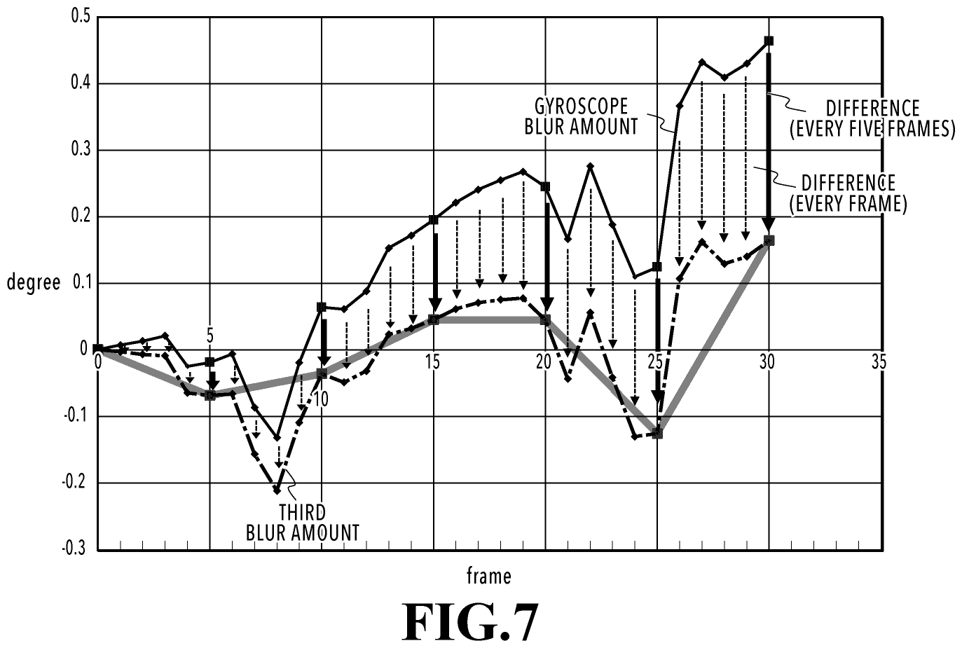

Next, a combined blur amount is calculated from the gyroscope blur amount based on the difference. FIG. 7 is a conceptual diagram of the calculation of the combined blur amount at every frame based on the difference of FIG. 6. As illustrated in FIG. 7, the difference at every five frames is converted to a difference at every one frame, and the converted difference is subtracted from the gyroscope blur amount of each frame to calculate the combined blur amount. Returning to FIG. 3, to sum it up, the frame interval of the second blur amount integral value corresponding to the gyroscope blur amount and the frame interval of the first blur amount integral value corresponding to the image blur amount are made to match each other. Then, the third blur amount integral value at each of the points 804 (points of triangle symbols and the line connecting these points) is calculated based on the integral value of the gyroscope blur amounts obtained at the frame interval of one frame in this range. The blur amount of each frame can be thereby calculated even in the case where the calculation of the image blur amount is omitted every several frames, and the speed of the stabilizing process can be increased.

### Operation Example

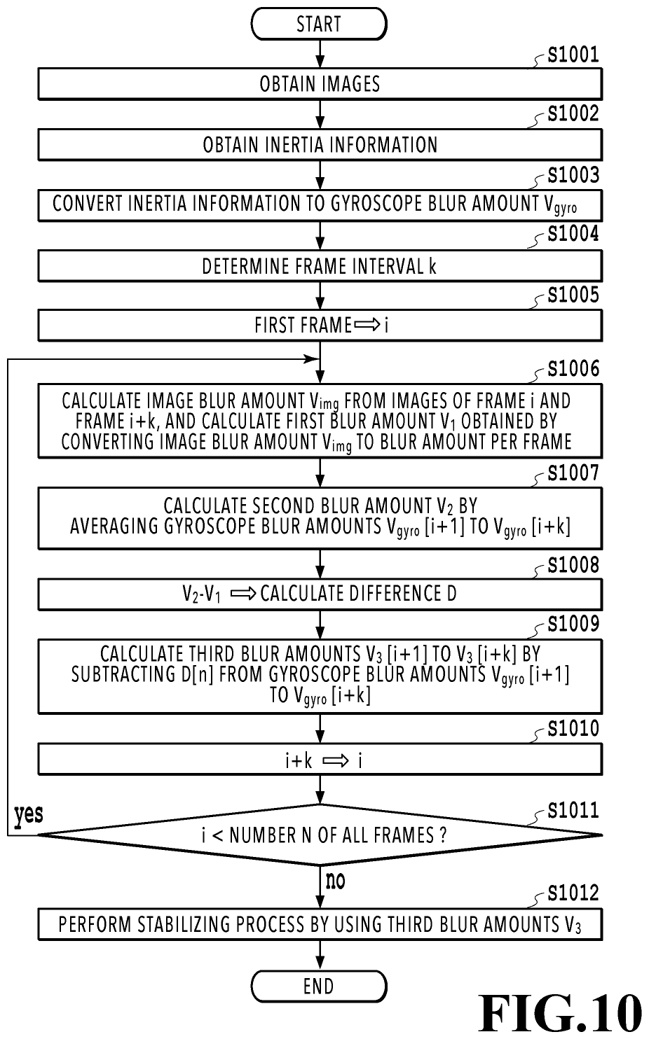

FIG. 10 is a flowchart explaining an operation example of Embodiment 1. The CPU 101 implements the process illustrated in FIG. 10 by executing a program stored in the RAM 102 or the ROM 103. The process illustrated in FIG. 10 is executed at a timing at which an operation of the stabilizing process start button 1103 in FIG. 9A is received. Note that some or all of functions in the steps of FIG. 10 may be realized by hardware such as an ASIC or an electronic circuit. A symbol “S” in explanation of each process means a step in the flowchart. Moreover, the process illustrated in FIG. 10 can also be realized as a cloud computing configuration in which one function is shared by multiple resources and processed collaboratively via the Internet, as long as it realized various functions of the image processing device 100. In the following explanation, the processes of S1001 to S1012 in FIG. 10 will be explained assuming that they are sequentially executed, but are not particularly limited to this order. For example, the process of S1006 may be executed after the process of S1007, since it is sufficient that the first blur amount V₁ and the second blur amount V₂ have been calculated by the time of the process of S1008.

In S1001, the CPU 101 obtains the images. In S1002, the CPU 101 obtains the inertia information. The inertia information is assumed to be generated by the gyroscope sensor incorporated in the imaging apparatus or the like and recorded in the video file 1000 as illustrated in FIGS. 8A and 8B. In S1002, the CPU 101 obtains all pieces of inertia information 1004 at the respective frames recorded in the video file 1000.

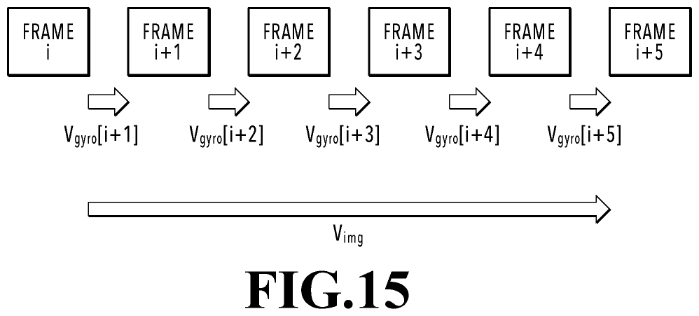

In S1003, the CPU 101 converts the inertia information to the gyroscope blur amount V_{gyro}. Specifically, for each frame, the CPU 101 divides each of the pan, tilt, and roll expressed as the angular velocities [degree/second] by the frame rate to obtain the gyroscope blur amount V_{gyro} converted into the unit of [degree/frame]. For example, a slope of the fine line connecting the rhombus symbols of the points 801 in FIG. 3 is the gyroscope blur amount V_{gyro}. The method of calculating the gyroscope blur amount for one frame is not limited to the method described above. Other publicly-known methods may be used. A relationship between the frame and the gyroscope blur amount V_{gyro} are described by using FIG. 15. FIG. 15 is a diagram explaining a relationship between the blur amount and the image. As illustrated in FIG. 15, the gyroscope blur amount V_{gyro} [i+1] of the frame i+1 is a difference between the angle of the imaging apparatus at the moment where the frame i+1 is captured and the angle of the imaging apparatus at the moment where the frame i is captured.

In S1004, the CPU 101 determines the frame interval k of the images. As described by using FIGS. 9A and 9B, in the present embodiment, k is determined based on the user selection.

In S1005, the CPU 101 sets an index of the first frame as an index i of the frame. Since the frame i is referred to as the first frame by this setting, the image of the frame i is referred to as an image of the first frame. Accordingly, the image of the frame i+k is referred to as an image of the k-th frame from the first frame.

In S1006, the CPU 101 calculates the image blur amount V_{img} from the image of the frame i and the image of the frame i+k. The image blur amount V_{img} is calculated based on the motion vector calculated from the two images. Specifically, the optimization process is performed to calculate such a rotation amount that the squared error between the coordinates of the feature point in the frame i+k and the rotated coordinates obtained by performing the three-dimensional rotation process on the coordinates of the feature point detected in the image of the frame i to rotate the coordinates is minimized. The rotation amount calculated as described above is set as the image blur amount V_{img}. The method of obtaining the rotation amount from the motion vector is not limited to that described above, and other publicly-known methods may be used. The relationship between the frame and the image blur amount V_{img} is described by using FIG. 15. FIG. 15 illustrates a case where k is set to 5.

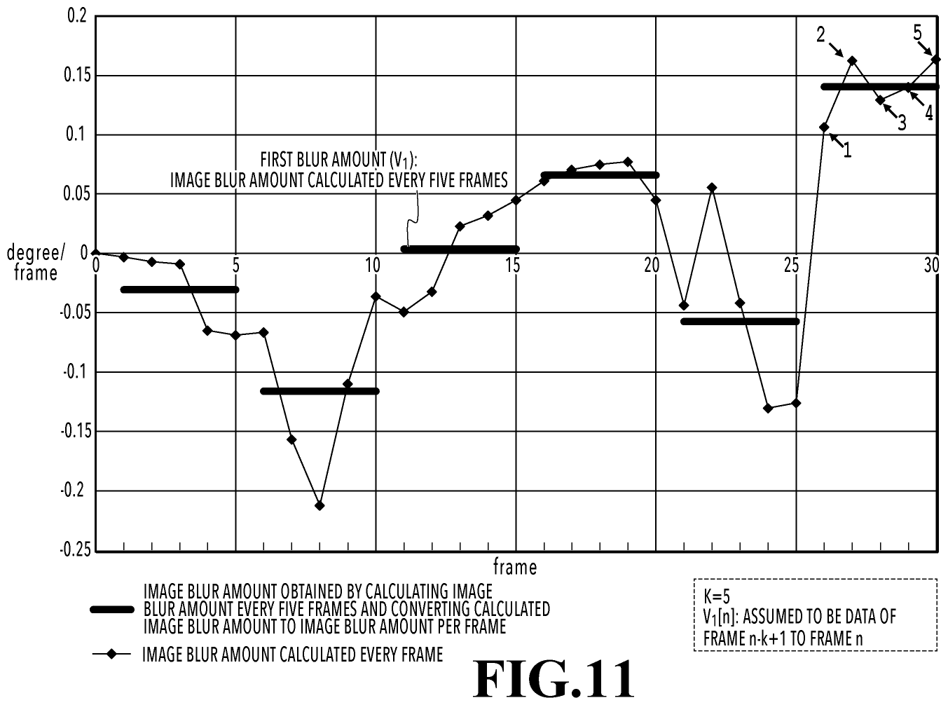

In this case, the image blur amount V_{img} of FIG. 15 is calculated from the image of the frame i and the image of the frame i+k. Accordingly, the image blur amount V_{img} is the rotational amount for k frames. The image blur amount V_{img} is expressed as the vector including three elements of pan (yaw), tilt (pitch), and roll. Accordingly, the blur amount per frame obtained by dividing the image blur amount V_{img} of each of pan, tilt, and roll by k is set as the first blur amount V₁. FIG. 11 is a diagram schematically illustrating the first blur amount V₁ in S1006 of FIG. 10. As illustrated in FIG. 11, the first blur amount V₁ is converted to the image blur amount per frame, every five frames. Accordingly, the first blur amount V₁ indicates the average rotation amount in the range of k frames. For example, the slope of the bold line connecting the square symbols of the points 802 in FIG. 3 is the first blur amount V₁. Note that, although only one of the elements of pan, tilt, and roll is illustrated in the graph of FIG. 3, total of three graphs that are similar to the graph of FIG. 3 are present for pan, tilt, and roll, respectively, in actual. However, since the processes are the same for all elements, explanation is given herein by using only one of the elements.

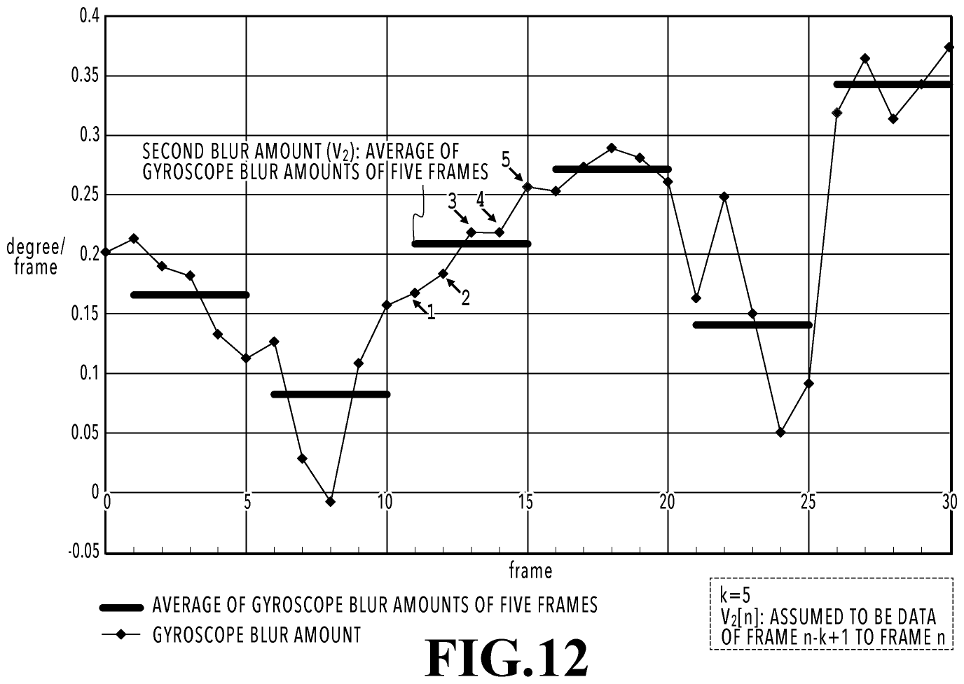

In S1007, the CPU 101 calculates the second blur amount V₂ by averaging the gyroscope blur amounts V_{gyro} of the frame i+1 to the frame i+k. The data obtained from the gyroscope sensor is also expressed as the vector including three elements of pan, tilt, and roll. Accordingly, the second blur amount V₂ is also expressed as the vector including the three elements. The second blur amount V₂ indicates the average rotation amount in the range of k frames. FIG. 12 is a diagram schematically illustrating the second blur amount V₂ in S1007 of FIG. 10. As illustrated in FIG. 12, the second blur amount V₂ is an average of the gyroscope blur amounts V_{gyro} of five frames.

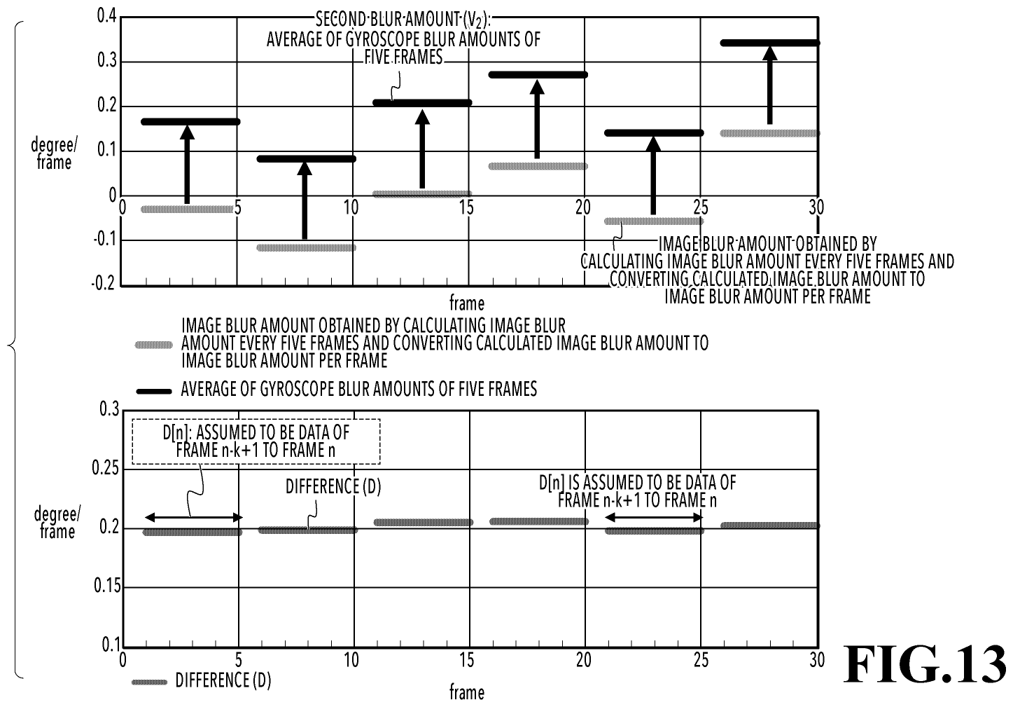

In S1008, the CPU 101 calculates the difference D between the first blur amount V₁ and the second blur amount V₂ by subtracting the first blur amount V₁ from the second blur amount V₂. The difference D is an average value of the difference between the second blur amount V₂ calculated by using the inertia information and the first blur amount V₁ calculated by using the video in the range of k frames. FIG. 13 is a diagram schematically illustrating the difference in S1008 of FIG. 10. As illustrated in FIG. 13, the difference D is calculated every five frames, and is calculated by subtracting the first blur amount V₁ that is the image blur amount converted to the blur amount per frame from the second blur amount V₂ that is the average of the gyroscope blur amounts V_{gyro} of five frames.

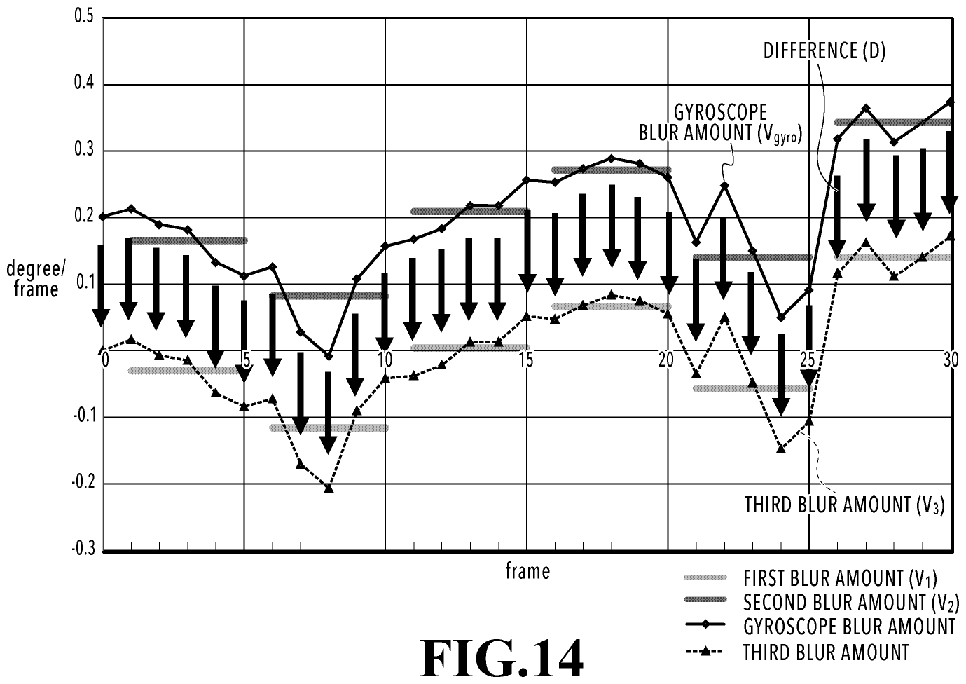

In S1009, the CPU 101 performs calculation on the gyroscope blur amount V_{gyro} of each of the frame i+1 to the frame i+k to calculate the third blur amount V₃ of the each of the frame i+1 to the frame i+k, as V₃=V_{gyro}−D. FIG. 14 is a diagram schematically illustrating the third blur amount V₃ in S1009 of FIG. 10. In the case where the image blur amount calculated every frame in FIG. 11 and the third blur amount V₃ in FIG. 14 are compared with each other, the value of the third blur amount V₃ is substantially the same as the value of the image blur amount calculated every frame assuming that k is 1 (image blur amount calculated every frame in FIG. 11). In other words, stabilizing process similar to that in the case where the image blur amount is calculated every frame can be achieved by using the third blur amount V₃ without calculation of the image blur amount for every frame that takes time.

In S1010, the CPU 101 advances the index i of the frame by k frames. In S1011, the CPU 101 performs a loop process until scanning of all frames is completed. In the case where i exceeds N that is the last frame of the video, the CPU 101 terminates the process. In the case where i does not exceed N, the CPU 101 returns to S1006 and repeats the process. In S1012, the CPU 101 performs the stabilizing process on the video by using the third blur amounts V₃. Since each third blur amount V₃ indicates the rotation vector from the one-previous frame, rotating the current frame in the direction opposite to this rotation vector enables obtaining of a current frame that is not rotated (not blurred) with respect to the previous frame. Since a method of performing the stabilizing process on the video by using the third blur amounts V₃ is publicly-known, detailed explanation thereof is omitted.

According to the present embodiment, the blur amounts calculated at the predetermined intervals from the inertia information obtained from the gyroscope sensor and the consecutive images captured by the imaging apparatus are combined as described above. This can remove the offset component of the inertia information and achieve an increase in the speed of the stabilizing process while maintaining the accuracy of the blur amount of the image.

### Embodiment 2

In Embodiment 1, explanation is given of the method in which the blur amount calculation is performed at the fixed frame interval k corresponding to the imaging condition selected by the user. However, in actual, it is difficult to uniquely estimate the frequency of blur from the imaging condition instructed and inputted. In the case where the frequency of the blur is low with respect to the set frame interval k, there is a possibility that the calculation interval of image blur is excessively small, and execution of many times of the blur amount calculation becomes a wasteful process. Moreover, in the case where the frequency of the blur is high with respect to the set frame interval k, if the calculation interval of the image blur amount is large, there may be a case where the image blur amount swings back and the translational blur cannot be correctly expressed.

Accordingly, in the present embodiment, an explanation is given of a method in which the inertia information obtained from the gyroscope sensor is analyzed to change the frame interval k to a more-appropriate value depending on the condition to appropriately control the calculation interval of the image blur amount and perform processing at higher accuracy and at higher speed.

It is normally impossible to know the frequency of the translational blur by analyzing the inertia information including no translational blur component. However, the case where the rotation blur and the translational blur have different frequencies is rare. Specifically, in order to rotate the imaging apparatus without translationally moving the imaging apparatus, the imaging apparatus needs to be rotated about a portion referred to as an entrance pupil (nodal point) of a lens of the imaging apparatus. However, the case where the rotation center and the entrance pupil are completely identical to each other is rare. Accordingly, the cycle of the rotation and the cycle of translation are the same in the motion of the imaging apparatus in most cases. Hence, the frequency of the rotation blur and the frequency of the translational blur are assumed to be the same. Thus, the frequency of the translational blur included in the image blur can be estimated by analyzing the inertia information obtained from the gyroscope sensor.

### Logical Configuration

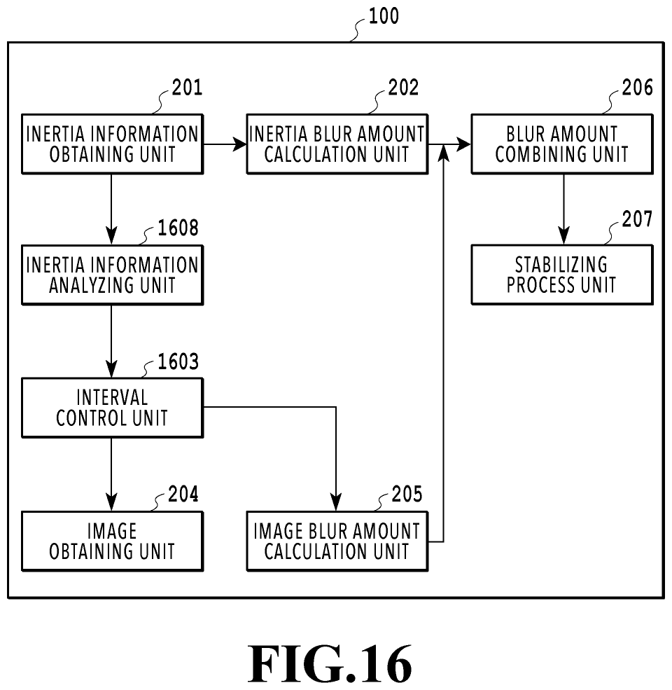

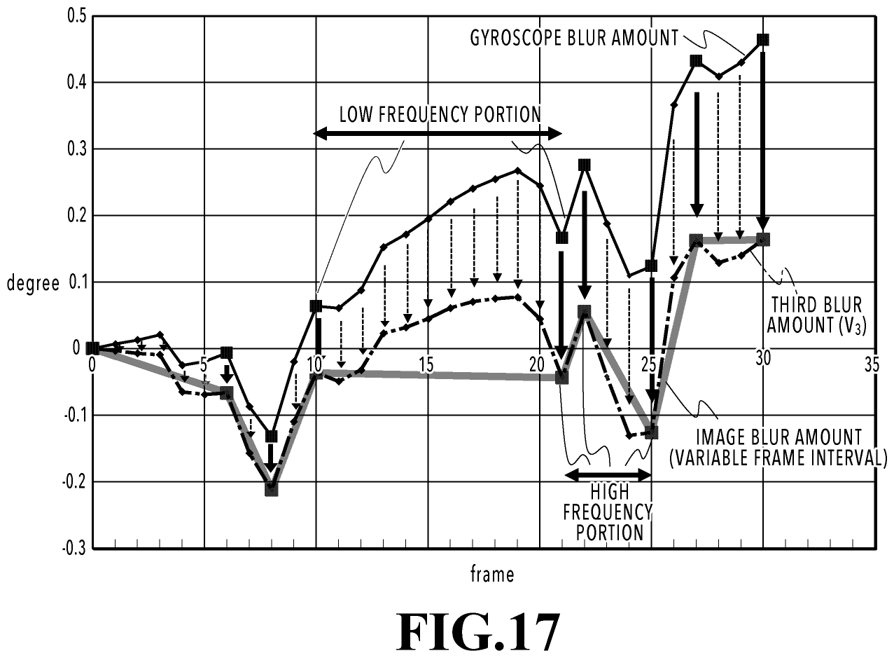

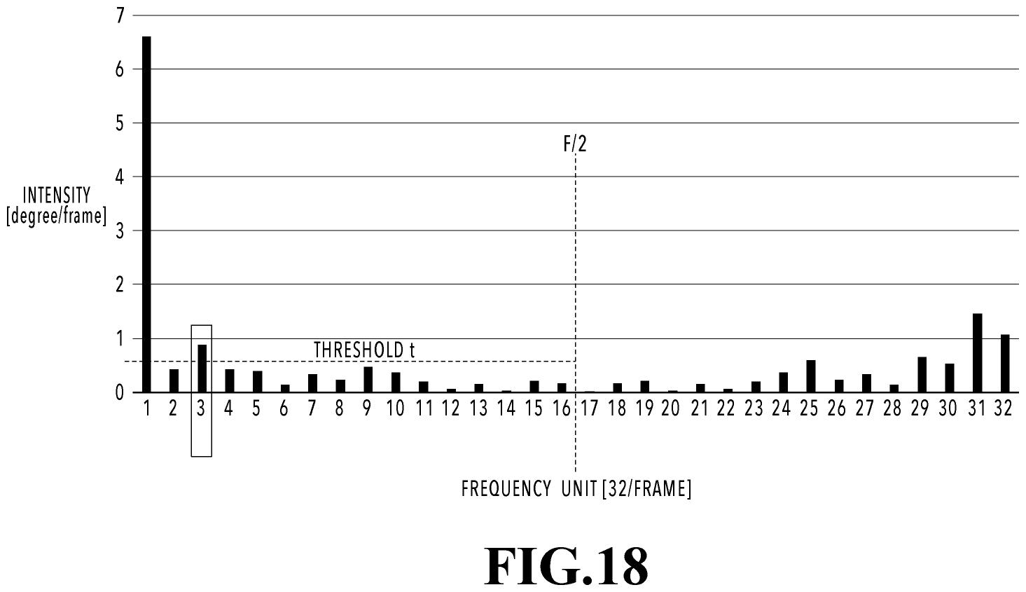

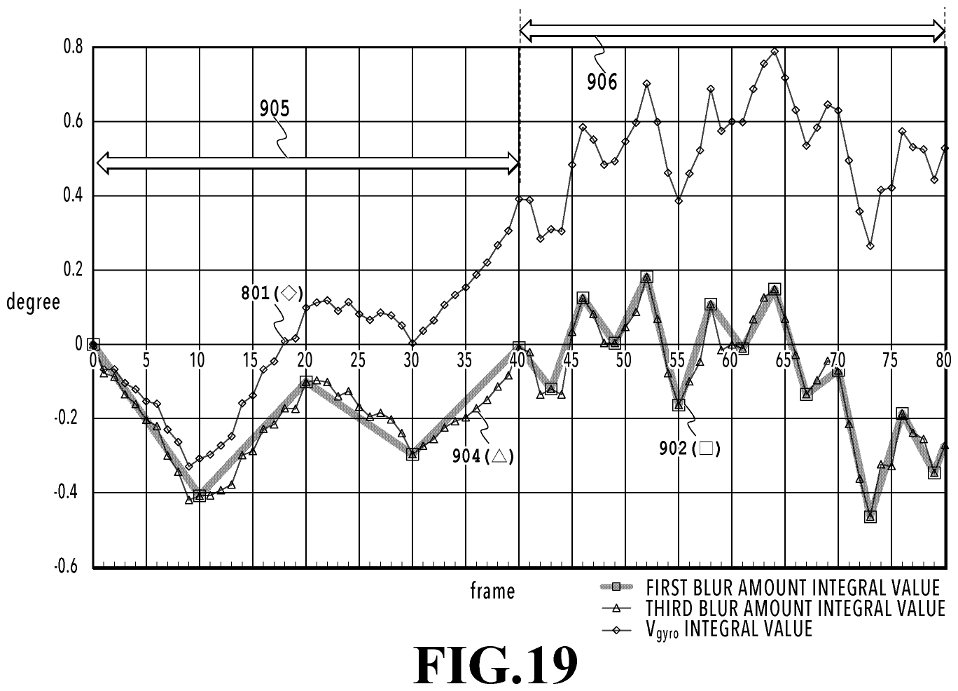

FIG. 16 is a block diagram illustrating a logical configuration of Embodiment 2. The image processing apparatus 100 in the present embodiment is formed of the inertia information obtaining unit 201, the inertia blur amount calculation unit 202, an interval control unit 1603, the image obtaining unit 204, the image blur amount calculation unit 205, the blur amount combining unit 206, the stabilizing process unit 207, and an inertia information analyzing unit 1608. Since the inertia information obtaining unit 201, the inertia blur amount calculation unit 202, the image obtaining unit 204, the image blur amount calculation unit 205, and the blur amount combining unit 206 in FIG. 16 are the same as those in Embodiment 1, explanation thereof is omitted. The inertia information analyzing unit 1608 obtains the inertia information from the inertia information obtaining unit 201, and analyzes a vibration component of the inertia information. The interval control unit 1603 sets an appropriate frame interval k depending on the condition, based on the vibration component. FIG. 17 is a schematic diagram in which the frame interval k of the image blur amount is changed in a low frequency portion and in a high frequency portion in Embodiment 2. As illustrated in FIG. 17, the frame interval k at which the image blur amount is calculated is increased in the low frequency portion, and is reduced in the high frequency portion. This reduces the calculation frequency of the image blur amount that takes time in the low frequency portion, and a further speed increase can be achieved. The changing of the frame interval k is determined based on an analysis result of the inertia information. FIG. 18 is a diagram explaining the analysis result of the inertia information in Embodiment 2. In FIG. 18, F/2 is the Nyquist frequency, where F is the sampling frequency. Accordingly, frequencies higher than F/2 are invalid. Moreover, a threshold t indicates a reference of noticeableness of blur. In FIG. 18, a frequency 3 is the highest frequency that is equal to or smaller than F/2 and the highest frequency whose intensity [degree] exceeds the threshold t among the frequencies f [F/frame]. Accordingly, cycle p=F÷f=32÷3=10.7 [frames]. In this case, half cycle k′=p÷2=10.7÷2=5.3 [frames]. In this case, the half cycle k′ is obtained to enable reproduction of one rise or one fall of a change of blur. In the case where k′ (=5.3) frames or more have proceeded from the frame i in which the previous blur amount has been calculated, the image blur amount between the frame i and the frame i+k is calculated with the frame interval k set to 6 by rounding up the half cycle k′. Note that the threshold t may be a function of the sampling frequency F. For example, the configuration may be such that g is set as a counter of scanning of F, and the threshold t is determined based on g and F. FIG. 19 is a graph explaining an outline of Embodiment 2. Since points 801 in FIG. 19 are the same as the points 801 in FIG. 3, explanation thereof is omitted. Points 902 are integral values of the image blur amounts that are expressed by points of square symbols and a bold line connecting these points to one another and that are calculated from the motion vectors of the images. Since no high frequency blur appeared in a section 905 as a result of analyzing the integral values of the gyroscope blur amounts at the points 801 and determining the frame interval k, the frame interval k is set to 10. The points 902 expressing the integral values of the image blur amount are thereby calculated at an interval of 10 frames in the section 905, and the speed of the stabilizing process can be increased from that in the case where the process is performed at the fixed frame interval. Meanwhile, since high frequency blur appeared in a section 906, the frame interval k is set to 3. This enables calculation of points 904 expressing the third blur amount integral values in the section 906 with appropriate accuracy maintained.

### Operation Example

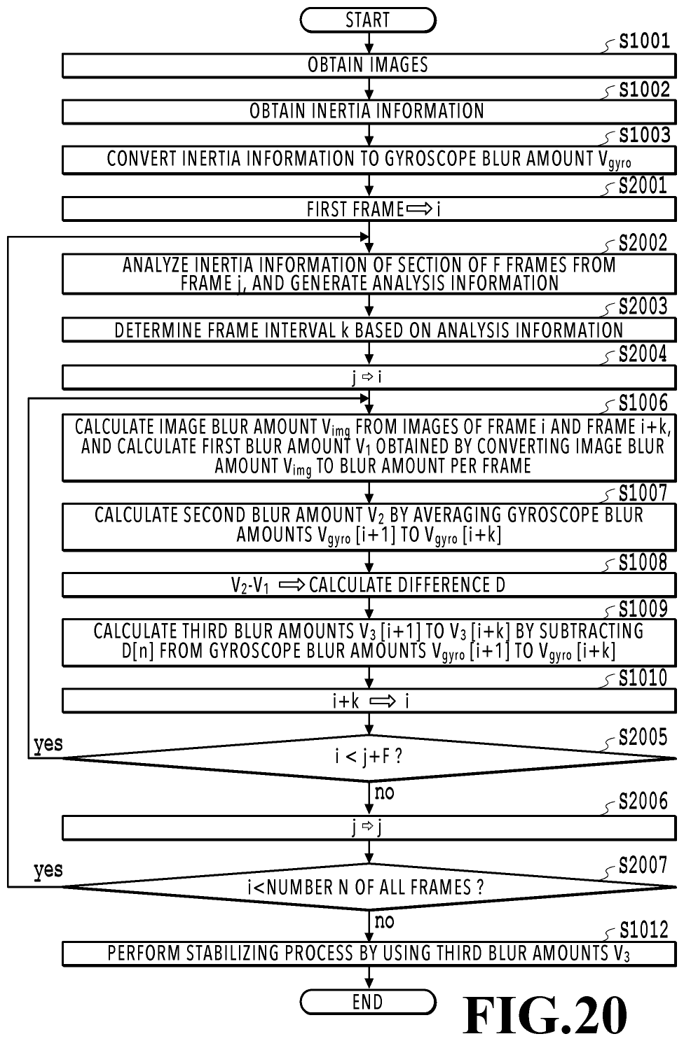

FIG. 20 is a flowchart explaining an operation example of Embodiment 2. The CPU 101 implements a process illustrated in FIG. 20 by executing a program stored in the RAM 102 or the ROM 103. The process illustrated in FIG. 20 is executed at a timing at which the stabilizing process start button 1103 of FIG. 9A receives an operation. Note that some or all of functions in the steps of FIG. 20 may be implemented by hardware such as an ASIC or an electronic circuit. A symbol “S” in explanation of each process means step in the flowchart. Moreover, the process illustrated in FIG. 20 only needs to implement various functions of the image processing apparatus 100, and can be implemented as a configuration of cloud computing in which multiple resources handle one function in a shared manner and process the one function in collaboration via the Internet.

Since the processes of S1001, S1002, and S1003 are the same processes as those in Embodiment 1, specific explanation thereof is omitted. In S2001, the CPU 101 sets the index of the first frame as an index j of a frame. In S2002, the CPU 101 analyzes the inertia information of a section of F frames from the frame j, and generates analysis information. First, the gyroscope blur amounts V_{gyro} are subjected to numerical integration to calculate integral values. Fast Fourier transform (FFT) analysis is performed on the integral values in the section of F frames from the frame j, and frequency components are generated. These frequency components are used as the analysis information. For example, the frequency components are expressed by the graph of FIG. 18 described above.

In S2003, the CPU 101 calculates the frame interval k in the section of F frames from the frame j. Half cycle k′=F÷f÷2 is calculated for the highest frequency f whose intensity exceeds the threshold t [degree] indicating reference of noticeableness of blur in the result of FFT. The unit of the frequency f is [F/frame]. The unit of the half cycle k′ is [frame]. The unit of the intensity is [degree]. Moreover, in searching for the highest frequency f whose intensity exceeds the threshold t, a portion exceeding F/2 that is the Nyquist frequency is not scanned. For example, in explanation using the graph of FIG. 18, in the case where threshold t=0.5, the frequency 3 [F/frame] is the highest frequency whose intensity exceeds the threshold t among the frequencies equal to or lower than F/2, and f is thus set to 3. The half cycle k′ for this f is F÷f÷2=5.3. Note that the threshold t is experientially determined to t=0.5 [degree] in this example. Meanwhile, since an amount at which blur becomes noticeable varies depending on the frequency, t may be set as a function of the frequency. For example, t may be determined such as t=0.1+g×F/2 (g is counter of scanning of frequencies). The half cycle k′ is rounded up, and is set as the frame interval k.

In S2004, the CPU 101 sets j as the index i of the frame. This index i is the same as the index i used in Embodiment 1. Since S1006, S1007, S1008, S1009, and S1010 are the same processes as those in Embodiment 1, explanation of these processes is omitted. In S2005, the CPU 101 determines whether the third blur amount is calculated for all frames from the frame k to the frame j+K for which the frame interval k is determined. In the case where i is smaller than j+F, the scanning of all frames is not completed yet, and the CPU 101 returns to S1006. In the case where i is equal to or more than j+F, the CPU 101 determines that the scanning of all frames is completed, and proceeds to S2006. In S2006, the CPU 101 sets j as the current i. Since F is not necessarily a multiple of k, i does not necessarily match j+F in S2005. In this case, i exceeds j+F, and the calculation of the third blur amount is performed beyond the section of F frames for which the analysis information is generated in some cases. In this respect, in S2006, the CPU 101 may perform rollback by setting j as i−k, and then go into the processing of the next section of F frames. In S2007, the CPU 101 determines whether the scanning of all frames for j is completed or not. In the case where j is smaller than the number N of all frames, the CPU 101 returns to S2002. In the case where j is equal to or larger than N, the CPU 101 proceeds to S1012. S1012 is the same as that in Embodiment 1, and the stabilizing process is performed on the images based on the third blur amounts. Then, the process is terminated.

Determining the frame interval k at which the blur calculation based on the image information is performed from the analysis result of the inertia information as described above causes the calculation interval of the image blur amount to be greatly increased in the case where the imaging apparatus vibrates at low frequency, and the speed of the stabilizing process can be thereby increased. Meanwhile, setting the calculation interval of the image blur to a small interval in the case where the imaging apparatus vibrates at high frequency allows the blur amount including the translational blur component to be correctly calculated, and the accuracy of the stabilizing process can be maintained. For example, as illustrated in FIG. 19, since no high frequency blur appeared in the section 905 as a result of analyzing the integral values of the gyroscope blur amounts at the points 801 and determining the frame interval k, the frame interval k is set to 10. The integral values 902 (square symbols) of the image blur amounts are thereby calculated at an interval of 10 frames in the section 905, and the speed of the stabilizing process can be increased from that in the case where the process is performed at the fixed frame interval. Meanwhile, since high frequency blur appears in the section 906, the frame interval k is set to 3. The integral values 904 (triangle symbols) of blended blur amounts in the section 906 can be thereby calculated with appropriate accuracy maintained.

### Effects of Invention

According to the present disclosure, the blur amounts calculated at the predetermined intervals from the inertia information obtained from the gyroscope sensor and the consecutive images captured by the imaging apparatus are combined as described above. This can remove the offset component of the inertia information and also achieve an increase in the speed of the stabilizing process while maintaining the accuracy of the blur amount of the image.

### Other Embodiments

Although the various examples and embodiments of the present disclosure have been described and explained above, the spirit and scope of the present disclosure are not limited to the specific explanation in the present specification. The present disclosure is not limited to the above embodiments, and various modifications can be made. Moreover, in the present disclosure, parts of the above-mentioned embodiments may be combined as appropriate.

Furthermore, although the example in which the image processing apparatus 100 obtains the video file 1000 via the flash memory is explained in the present embodiments, the present disclosure is not limited to this. For example, the video file 1000 may be obtained via radio. In this case, the image processing apparatus 100 only needs to include a function of a not-illustrated radio communication unit.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084062, filed on May 23, 2024, which is hereby incorporated by reference herein in its entirety.

What is claimed is:

1. An image processing apparatus comprising:
an image blur amount calculation unit configured to calculate a first blur amount per frame based on a blur amount between images apart from each other by a predetermined number of frames among consecutive images captured by an imaging apparatus;
an inertia blur amount calculation unit configured to calculate a second blur amount per frame based on inertia information of a plurality of frames detected in response to shaking of the imaging apparatus; and
a blur amount combining unit configured to subtract a difference from the inertia information to calculate a third blur amount used for stabilization of the consecutive images captured by the imaging apparatus, the difference obtained by subtracting the first blur amount from the second blur amount.

2. The image processing apparatus according to claim 1, wherein the inertia blur amount calculation unit calculates the second blur amount per frame by averaging gyroscope blur amounts obtained by converting the inertia information of the plurality of frames into blur amounts of the respective frames.

3. The image processing apparatus according to claim 2, wherein the inertia information is calculated for each of the frames, based on an inertia rotation amount for each of three axes orthogonal to one another.

4. The image processing apparatus according to claim 3, wherein
the three axes are a pan axis, a tilt axis, and a roll axis, and
the inertia rotation amount is expressed as an angular velocity for each of the pan axis, the tilt axis, and the roll axis.

5. The image processing apparatus according to claim 4, wherein the inertia blur amount calculation unit performs the conversion to the gyroscope blur amounts based on the angular velocity for each of the pan axis, the tilt axis, and the roll axis and a frame rate of the imaging apparatus.

6. The image processing apparatus according to claim 1, wherein the blur amount between the images is an image rotation amount at which an error is minimized, the error being an error between rotated coordinates obtained by performing a three-dimensional rotation process on coordinates of a feature point detected in one of the images apart from each other by the predetermined number of frames and coordinates of a feature point detected in the other one of the images apart from each other by the predetermined number of frames.

7. The image processing apparatus according to claim 6, wherein the image rotation amount is a rotation amount for each of three axes orthogonal to one another, and is expressed by a vector of each of a pan axis, a tilt axis, and a roll axis.

8. The image processing apparatus according to claim 3, wherein the larger the inertia rotation amount is, the smaller the predetermined number of frames is set.

9. The image processing apparatus according to claim 1, further comprising an analysis unit configured to determine the predetermined number of frames based on analysis information obtained by analyzing the inertia information.

10. The image processing apparatus according to claim 9, wherein the analysis unit uses a frequency components generated from the inertia information as the analysis information.

11. The image processing apparatus according to claim 10, further comprising an interval control unit configured to select a highest frequency among frequencies that are included in the frequency component and that have intensities exceeding a threshold set in advance and set a natural number equal to or more than a half cycle of a cycle corresponding to the selected frequency as the predetermined number of frames.

12. The image processing apparatus according to claim 11, wherein the interval control unit extracts the frequencies with intensities exceeding the threshold set in advance from frequencies being equal to or lower than a half of the frequencies included in the frequency components.

13. The image processing apparatus according to claim 10, further comprising an interval control unit configured to perform control of increasing the predetermined number of frames as the frequency components become lower and perform control of reducing the predetermined number of frames as the frequency components become higher.

14. An image processing method comprising:
calculating a first blur amount per frame based on a blur amount between images apart from each other by a predetermined number of frames among consecutive images captured by an imaging apparatus;
calculating a second blur amount per frame based on inertia information of a plurality of frames detected in response to shaking of the imaging apparatus; and
subtracting a difference from the inertia information to calculate a third blur amount used for stabilization of the consecutive images captured by the imaging apparatus, the difference obtained by subtracting the first blur amount from the second blur amount.

15. A computer readable recording medium storing a program that causes a computer to execute:
calculating a first blur amount per frame based on a blur amount between images apart from each other by a predetermined number of frames among consecutive images captured by an imaging apparatus;
calculating a second blur amount per frame based on inertia information of a plurality of frames detected in response to shaking of the imaging apparatus; and
subtracting a difference from the inertia information to calculate a third blur amount used for stabilization of the consecutive images captured by the imaging apparatus, the difference obtained by subtracting the first blur amount from the second blur amount.
